(19) United States
(12) Patent Application Publication
(10) Pub. No.: US 2024/0123610 A1
(43) Pub. Date: Apr. 18, 2024

(54) TORQUE-LIMITED BRAKING OF A ROBOT MANIPULATOR

(71) Applicant: Franka Emika GmbH, Müvchen (DE)

(72) Inventors: Andreas Spenninger, Karlsfeld (DE); Dmitrij Forssilow, München (DE)

(21) Appl. No.: 17/769,419

(22) PCT Filed: Oct. 15, 2020
(86) PCT No.: PCT/EP2020/078981

§ 371 Date: Apr. 15, 2022

(30) Foreign Application Priority Data
Oct. 17, 2019 (DE) 10 2019 128 082.6

(51) Int. Cl. B25J 9/16; B25J 9/10; B25J 19/00

(52) U.S. Cl. CPC B25J 9/1605; B25J 9/106; B25J 9/1607; B25J 19/0004; B25J 13/085

(57) ABSTRACT

The invention relates to a robot manipulator, wherein a braking device arranged on at least one of the joints of the manipulator is activated by a control unit in order to generate such a residual torque that a maximum torque is not exceeded at the joint, and the residual torque is determined on the basis of sensor determination and/or estimation of the torque currently present at the joint, wherein the estimation is based on a measure, multiplied by a first predefined factor, of a gravitational influence acting on the at least one of the joints, or is based on a dynamic model of the robot manipulator, the dynamic model having the gravitational influence, wherein the control unit determines the gravitational influence on the basis of a joint angle vector with joint angles between the at least one of the joints and a distal end of the robot manipulator.

### CROSS-REFERENCE TO RELATED APPLICATIONS

The present application is the U.S. National Phase of PCT/EP2020/078981, filed on 15 Oct. 2020, which claims priority to German Patent Application No. 10 2019 128 082.6, filed on 17 Oct. 2019, the entire contents of which are incorporated herein by reference.

### FIELD

The invention relates to a robot manipulator with a plurality of links interconnected by joints, with a control unit and, in particular, with a brake unit, and a method for activating a brake unit of a robot manipulator with a plurality of links connected to one another by such a control unit.

### SUMMARY

The object of the invention is to delay the movement of a robot manipulator in such a way that a maximum braking torque is not exceeded at a joint of the robot manipulator.

The invention results from the features of the independent claims. Advantageous refinements and embodiments are the subject matter of the dependent claims.

A first aspect of the invention relates to a robot manipulator with a plurality of links connected to one another by joints and with a control unit, wherein at least one of the joints has a braking device and the control unit is designed to activate the braking device to generate such a residual torque that a predefined maximum permissible torque is not exceeded at at least one of the joints, and the residual torque is determined on the basis of sensor determination and/or estimation of a torque currently present at the at least one of the joints, wherein the estimation is based on
a measure, multiplied by a first predefined factor, of a gravitational influence acting on the at least one of the joints, or is based on
a dynamic model of the robot manipulator,
   the dynamic model having the gravitational influence,
   wherein the control unit is designed to determine the gravitational influence on the basis of a known mass distribution of the robot manipulator and on the basis of a joint angle vector with joint angles between the at least one of the joints and a distal end of the robot manipulator.

The components of the robot manipulator, in particular, the links and the components at the joints, are subject to the influence of the earth's gravitational field due to their mass. In particular, those components that are arranged in front of and thus in the direction of the distal end from the at least one joint act with a force and/or a torque on at least one joint. If this at least one joint cannot accommodate this force and/or this torque, these components will fall towards the earth. In addition to this static gravitational influence, there can be a further component added to the force and/or added to the torque acting on the at least one joint when the robot manipulator moves, caused by the inertia of the mass of all components starting from the at least one joint, which inertia is responsible for a Coriolis acceleration or centrifugal acceleration.

The torque currently acting on the at least one joint is determined. This is done either by sensor determination, i.e., in particular a torque sensor detects the currently acting torque, in particular, by detecting a strain on an elastic material, the modulus of elasticity of which is known. As an alternative to (or in combination with) this, the torque currently acting on the at least one joint is determined by estimation. The estimation preferably occurs by multiplication of a measure of a gravitational influence acting on the at least one of the joints, with a first predefined factor:

τ_{J}=g(q)·f₁
where the following is described herein:
τ_{J}: estimation of the torque currently acting on the at least one joint;
q: the current joint angle vector at least with joint angles between the at least one of the joints and the distal end of the robot manipulator;
g(q): the gravitational influence as a function of the current joint angle vector; and
f₁: the first predefined factor, preferably chosen as f₁=140%.

Alternatively, the estimation preferably takes place by use of a dynamic model of the robot manipulator that exhibits the gravitational influence. This is explained in more detail in the further subsequent embodiments.

The control unit is preferably arranged on the robot itself, alternatively preferably only connected thereto using data technology. The torque to be generated by the braking device is generally to be considered a relative manipulated variable, so that the residual torque can be a braking torque of a mechanical brake as an absolute value, on the one hand; or the value of the residual torque, on the other hand, can be added to a manipulated variable generated by the control unit for an electric motor of the at least one joint, so that the residual torque accounts for only a portion of the absolute manipulated variable of the motor of the at least one joint. In the latter case, the brake unit corresponds to a motor of the at least one joint, i.e., it corresponds to a drive of the at least one joint, since a drive can be used both to generate a positive, accelerating, torque and a negative, decelerating, torque. The residual torque can also preferably be implemented by saturation in order to limit the manipulated variable for the motor of the at least one joint. The difference between the maximum permissible torque and the current torque at the at least one joint represents, in particular, an upper bound for the residual torque. The control unit is preferably designed to determine the residual torque to the extent of this difference. As a result, the highest possible residual torque is advantageously used without exceeding the predefined maximum permissible torque at the at least one joint.

An advantageous effect of the invention is that safety when operating a robot manipulator is increased, in particular, by a braking torque generated at at least one link of the robot manipulator being compared with a predefined limit such that the braking torque generated does not exceed the predefined limit.

According to an advantageous embodiment, the control unit is designed to determine the joint angle vector from a respective actuator position of a respective actuator, arranged on a respective joint, between the at least one of the joints and a distal end of the robot manipulator. According to this embodiment, the estimation of the current torque is determined by multiplication of a measure of a gravitational influence acting on the at least one of the joints, with the first predefined factor:

τ_{J}=g(θ)·f₁
or determined by the following in the case of a gearbox with the gear ration:

τ_{J}=g(n·θ)·f₁
where the following is indicated:
θ: a vector of actuator positions, particularly of motors on those joints, the joint angles of which q are determined in the above case; and
g(θ): the gravitational influence as a function of the current vector of the actuator positions.

According to a further advantageous embodiment, the control unit is designed to determine the gravitational influence on the basis of a mass distribution of the robot manipulator. The mass distribution of the robot manipulator preferably also comprises a relative position of a center of gravity of a load on the robot manipulator relative to the robot manipulator.

According to a further advantageous embodiment, the dynamic model of the robot manipulator has a mass matrix which is multiplied by a second time derivative of the joint angle vector and is dependent on the joint angle vector, and a Coriolis matrix, which is dependent on the joint angle vector and on the first time derivative of the joint angle vector, and a term for the gravitational influence which is dependent on the joint angle vector. The estimation is preferably determined by:

τ_{J}=M(q)\ddot{q}+C(q,\dot{q})+g(q)
where the following is described herein:
τ_{J}: estimation of the torque currently acting on the at least one joint;
q: the current joint angle vector at least with joint angles between the at least one of the joints and the distal end of the robot manipulator;
M(q): a current mass matrix of robot manipulator components as a function of the current joint angle vector;
C(q,\dot{q}): a current Coriolis matrix of robot manipulator components as a function of the current joint angle vector and a first time derivative thereof; and
g(q): the gravitational influence as a function of the current joint angle vector.

According to a further advantageous embodiment, the dynamic model of the robot manipulator has a constant measure for the mass matrix which is multiplied by the second time derivative of the joint angle vector and which is dependent on the joint angle vector, and a Coriolis matrix, which is dependent on the joint angle vector and on the first time derivative of the joint angle vector, and a term for the gravitational influence which is dependent on the joint angle vector. The estimation is preferably determined by the following with adaptation of the previous embodiment:

τ_{J}=B+C(q,\dot{q})+g(q)
where the following is described herein:
B: a given upper bound for the term M(q)\ddot{q}, as described above. The other variables of this equation are used as described in the previous embodiment.

According to a further advantageous embodiment, the dynamic model of the robot manipulator has a Coriolis matrix dependent on the joint angle vector and on the first time derivative of the joint angle vector and a term for the gravitational influence dependent on the joint angle vector, wherein the sum of the Coriolis matrix and the term for the gravitational influence is multiplied by a second predefined factor. The estimation is preferably determined by the following with adaptation of the aforementioned embodiment:

τ_{J}=f₂·(C(q,\dot{q})+g(q))
where the following is described herein:
f₂: the second predefined factor; the other variables of this equation are used as described in the previous embodiment.

According to a further advantageous embodiment, the first predefined factor and/or the second predefined factor is such that the limited braking torque does not exceed a predefined design case. A heuristic factor, which was used in the design for dimensioning components of the robot manipulator, in particular, at the at least one joint, is used for the first factor and/or the second factor, respectively. Advantageously, the particular maximum permissible torque which originates from the design phase of the robot manipulator is not exceeded.

According to a further advantageous embodiment, the robot manipulator has a torque sensor on the at least one of the joints, wherein the torque sensor is designed to carry out the sensor determination. The torque sensor is specifically designed to directly sense strain or displacement resulting from a force or torque acting on an elastic material with a known stress-strain ratio. A spoke-shaped torque sensor is preferably used.

According to a further advantageous embodiment, the control unit is designed to control the braking device for generating the residual torque by use of a saturation element with variable bounds, wherein the variable bounds are dependent on the predefined maximum permissible torque at the at least one of the joints and on the sensor determination and/or the estimation of the torque currently present at the at least one of the joints.

According to a further advantageous embodiment, each of the joints has a respective control unit, wherein the respective control unit is arranged on the respective one of the joints and is designed to control only the respective braking device arranged on the respective joint. According to this embodiment, the control unit is arranged on a respective joint with a respective brake. Advantageously, the so-called “master” of the robot manipulator does not have to take on the object of the invention, but rather the respective computing module on a respective joint is responsible for the respective braking device of the respective joint.

According to a further advantageous embodiment, the control unit is a central control unit of the robot manipulator, which is used for all joints with a braking device for performing the object according to the invention.

According to a further advantageous embodiment, the braking device is an electric motor for moving or braking links arranged on the at least one of the joints relative to one another. This embodiment corresponds to the case in which a drive of the robot manipulator is used both for positive acceleration and for negative deceleration of at least two links connected to one another by a joint. According to this embodiment, no further separate, in particular mechanical, braking device is advantageously required.

A further aspect of the invention relates to a method for activating a braking unit of a robot manipulator with a plurality of links connected to one another by joints by use of a control unit, wherein at least one of the joints has such a braking device, wherein the braking device is activated by the control unit to generate such a residual torque that a predefined maximum permissible torque is not exceeded at at least one of the joints, wherein the residual torque is determined by the control unit on the basis of sensor determination and/or estimation of a torque currently present at the at least one of the joints, wherein the estimation is based on
a measure, multiplied by a first predefined factor, of a gravitational influence acting on the at least one of the joints, or is based on
a dynamic model of the robot manipulator having a gravitational influence, wherein the gravitational influence is determined by the control unit on the basis of a joint angle vector with joint angles between the at least one of the joints and a distal end of the robot manipulator.

Advantages and preferred refinements of the proposed method result from an analogous and corresponding transfer of the statements made above in conjunction with the proposed robot manipulator.

Further advantages, features, and details will be apparent from the following description, in which—possibly with reference to the drawings—at least one example embodiment is described in detail. The same, similar, and/or functionally identical parts are provided with the same reference numerals.

### BRIEF DESCRIPTION OF THE DRAWINGS

In the drawings:

FIG. 1 shows a robot manipulator according to an example embodiment of the invention; and

FIG. 2 shows a robot manipulator according to a further example embodiment of the invention.

The illustrations in the figures are schematic and not to scale.

### DETAILED DESCRIPTION

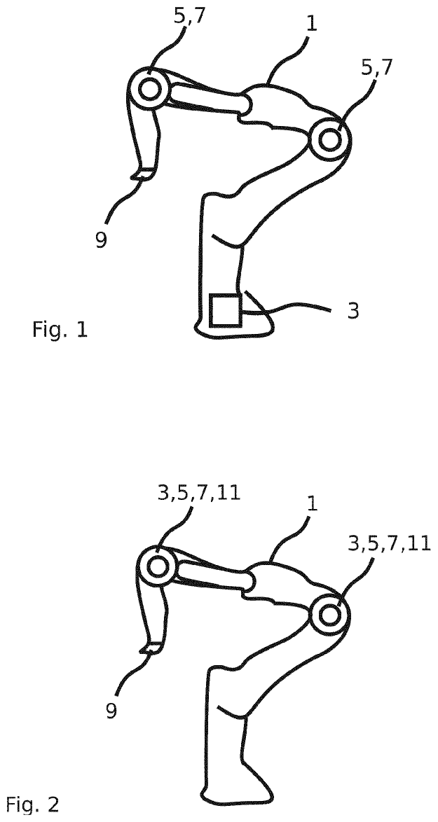

FIG. 1 shows a robot manipulator 1 with a plurality of links connected to one another by joints. The robot manipulator 1 has a central control unit 3, wherein a respective braking device 7 is arranged on each of the joints 5. In this case, the respective braking device 7 is a respective electric motor (drive) for moving or braking links arranged on the respective one of the joints 5 relative to one another. For the sake of simplicity, only two example joints 5 are shown in FIG. 1. The control unit 3 serves to generate such a respective residual torque for the respective braking device 7 that a respective predefined maximum permissible torque at the respective joint 5 is not exceeded. A specific maximum permissible torque is specified for each of the joints 5. The residual torque is determined on the basis of the maximum permissible torque at the respective joint and on the basis of an estimation of the torque currently present at the at least one of the joints 5, wherein the estimation is based on a dynamic model of the robot manipulator 1 that has the gravitational influence. The control unit 3 in this case determines the gravitational influence on the basis of a joint angle vector with joint angles between the at least one of the joints 5 and a distal end 9 of the robot manipulator 1. The dynamic model of the robot manipulator 1 has a mass matrix which is multiplied by a second time derivative of the joint angle vector and is dependent on the joint angle vector, and a Coriolis matrix, which is dependent on the joint angle vector and on the first time derivative of the joint angle vector, and a term for the gravitational influence which is dependent on the joint angle vector and is as follows:

τ_{J}=M(q)\ddot{q}+C(q,\dot{q})+g(q)
where the following is described herein:
τ_{J}: estimation of the torque currently acting on the at least one joint;
q: the current joint angle vector with joint angles between the at least one of the joints and the distal end 9 of the robot manipulator;
M(q): a current mass matrix of robot manipulator components as a function of the current joint angle vector;
C(q,\dot{q}): a current Coriolis matrix of robot manipulator components as a function of the current joint angle vector and a first time derivative thereof; and
g(q): the gravitational influence as a function of the current joint angle vector.

FIG. 2 shows a robot manipulator 1 again with a plurality of links connected to one another by joints 5. The robot manipulator 1 has a brake unit 7 with a respective control unit 3 on each of the joints 5. In this case, the respective braking device 7 is a respective electric motor (drive) for moving or braking links arranged on the respective one of the joints 5 relative to one another. For the sake of simplicity, only two example joints 5 are shown in FIG. 1. The respective control unit 3 serves to generate such a respective residual torque for the respective braking device 7 that a respective predefined maximum permissible torque at the respective joint 5 is not exceeded. A specific maximum permissible torque is specified for each of the joints 5. The respective residual torque is determined on the basis of the maximum permissible torque at the respective joint and on the basis of a sensor determination of the torque currently present at the respective joint 5. Each of the joints 5 has a respective torque sensor 11 for this purpose.

Although the invention has been further illustrated and described in detail by way of preferred example embodiments, the invention is not limited by the disclosed examples, and other variations can be derived therefrom by a person skilled in the art without departing from the scope of the invention. It is therefore clear that there is a plurality of possible variations. It is also clear that exemplified embodiments are really only examples, which are not to be construed in any way as limiting the scope, applicability, or configuration of the invention. Rather, the foregoing description and description of the figures enable a person skilled in the art to implement the example embodiments, and such person may make various changes knowing the disclosed inventive concept, for example with respect to the function or arrangement of individual elements cited in an example embodiment, without departing from the scope as defined by the claims and the legal equivalents thereof, such as a more extensive explanation in the description.

### LIST OF REFERENCE NUMERALS

1 Robot manipulator
3 Control unit
5 The at least one of the joints
7 Braking device
9 Distal end of the robot manipulator
11 Torque sensor

1. A robot manipulator comprising:
a plurality of links connected to one another by joints, wherein at least one of the joints includes a braking device; and
a control unit configured to:
activate the braking device to generate a residual torque such that a predefined maximum permissible torque is not exceeded at the at least one of the joints, the residual torque determinable based on sensor determination and/or estimation of a torque currently present at the at least one of the joints, wherein the estimation is based on a measure, multiplied by a first predefined factor, of a gravitational influence acting on the at least one of the joints, or is based on a dynamic model of the robot manipulator having the gravitational influence; and
determine the gravitational influence based on a known mass distribution of the robot manipulator and based on a joint angle vector with joint angles between the at least one of the joints and a distal end of the robot manipulator.

2. The robot manipulator according to claim 1, wherein the control unit is configured to determine the joint angle vector from a respective actuator position of a respective actuator, arranged on a respective joint, between the at least one of the joints and the distal end of the robot manipulator.

3. The robot manipulator according to claim 1, wherein the dynamic model of the robot manipulator includes:
a mass matrix that is multiplied by a second time derivative of the joint angle vector and is dependent on the joint angle vector;
a Coriolis matrix that is dependent on the joint angle vector and on a first time derivative of the joint angle vector; and
a term for the gravitational influence that is dependent on the joint angle vector.

4. The robot manipulator according to claim 1, wherein the dynamic model of the robot manipulator includes:
a constant measure for a mass matrix that is multiplied by a second time derivative of the joint angle vector and is dependent on the joint angle vector;
a Coriolis matrix that is dependent on the joint angle vector and on a first time derivative of the joint angle vector; and
a term for the gravitational influence that is dependent on the joint angle vector.

5. The robot manipulator according to claim 1, wherein the dynamic model of the robot manipulator includes:
a Coriolis matrix that is dependent on the joint angle vector and on a first time derivative of the joint angle vector; and
a term for the gravitational influence that is dependent on the joint angle vector, wherein a sum of the Coriolis matrix and the term for the gravitational influence is multiplied by a second predefined factor.

6. The robot manipulator according to claim 1, wherein the robot manipulator comprises a torque sensor on the at least one of the joints, wherein the torque sensor is configured to carry out the sensor determination.

7. The robot manipulator according to claim 1, wherein the control unit is configured to control the braking device for generating the residual torque using a saturation element with variable bounds, the variable bounds dependent on the predefined maximum permissible torque at the at least one of the joints, and on the sensor determination and/or the estimation of the torque currently present at the at least one of the joints.

8. The robot manipulator according to claim 1, wherein each of the joints includes a respective control unit arranged on a respective one of the joints, the respective control unit configured to activate only a respective braking device arranged on the respective one of the joints.

9. The robot manipulator according to claim 1, wherein the braking device is an electric motor to move or brake links arranged on the at least one of the joints relative to one another.

10. A method of braking a robot manipulator, the robot manipulator comprising a plurality of links connected to one another by joints, wherein at least one of the joints includes a braking device, the method comprising:
activating, using a control unit, the braking device to generate a residual torque such that a predefined maximum permissible torque is not exceeded at the at least one of the joints, wherein the residual torque is determinable by the control unit based on sensor determination and/or estimation of a torque currently present at the at least one of the joints, wherein the estimation is based on a measure, multiplied by a first predefined factor, of a gravitational influence acting on the at least one of the joints, or is based on a dynamic model of the robot manipulator having the gravitational influence; and
determining, using the control unit, the gravitational influence based on a joint angle vector with joint angles between the at least one of the joints and a distal end of the robot manipulator.

11. The method according to claim 10, wherein the method comprises determining, using the control unit, the joint angle vector from a respective actuator position of a respective actuator, arranged on a respective joint, between the at least one of the joints and the distal end of the robot manipulator.

12. The method according to claim 10, wherein the dynamic model of the robot manipulator includes:
a mass matrix that is multiplied by a second time derivative of the joint angle vector and is dependent on the joint angle vector;
a Coriolis matrix that is dependent on the joint angle vector and on a first time derivative of the joint angle vector; and
a term for the gravitational influence that is dependent on the joint angle vector.

13. The method according to claim 10, wherein the dynamic model of the robot manipulator includes:
a constant measure for a mass matrix that is multiplied by a second time derivative of the joint angle vector and is dependent on the joint angle vector;
a Coriolis matrix that is dependent on the joint angle vector and on a first time derivative of the joint angle vector; and
a term for the gravitational influence that is dependent on the joint angle vector.

14. The method according to claim 10, wherein the dynamic model of the robot manipulator includes:
a Coriolis matrix that is dependent on the joint angle vector and on a first time derivative of the joint angle vector; and
a term for the gravitational influence that is dependent on the joint angle vector, wherein the method comprises multiplying a sum of the Coriolis matrix and the term for the gravitational influence by a second predefined factor.

15. The method according to claim 10, wherein the robot manipulator comprises a torque sensor on the at least one of the joints, wherein the method comprises carrying out the sensor determination using the torque sensor.

16. The method according to claim 10, wherein the method comprises controlling, using the control unit, the braking device to generate the residual torque using a saturation element with variable bounds, the variable bounds dependent on the predefined maximum permissible torque at the at least one of the joints, and on the sensor determination and/or the estimation of the torque currently present at the at least one of the joints.

17. The method according to claim 10, wherein each of the joints includes a respective control unit arranged on a respective one of the joints, wherein the method comprises activating, using the respective control unit, only a respective braking device arranged on the respective one of the joints.

18. The method according to claim 10, wherein the braking device is an electric motor, wherein the method comprises moving or braking links arranged on the at least one of the joints relative to one another using the electric motor.
